(19) United States
(12) Patent Application Publication
(10) Pub. No.: US 2004/0055958 A1
(43) Pub. Date: Mar. 25, 2004

(54) System and method for removing heavy metal from wastewater

(76) Inventors: Rolando Roque-Malherbe, (US); William del Valle-Gonzales, (US); Eduardo Mendoza-Benitez, (US)

Correspondence Address: SHAW PITTMAN, IP GROUP, 1650 TYSONS BOULEVARD, SUITE 1300, MCLEAN, VA, 22102, US

(21) Appl. No.: 10/428,927

(22) Filed: May 5, 2003

Related U.S. Application Data
(60) Provisional application No. 60/380,866, filed on May 17, 2002.

(51) Int. Cl. C02F 1/42

(52) U.S. Cl. 210/688; 210/282

(57) ABSTRACT

The invention is directed to a method and system for removing heavy metals from wastewater using a natural zeolite ionic exchange bed that has a mass transfer zone sized based on the hydraulic loading of the wastewater. Preferably, the mass transfer zone has a distance that is about 125 to about 130 times the hydraulic loading. The method and system can include (a) analyzing the wastewater to be treated to determine and quantify the contained heavy metals; (b) determining the wastewater flow rate; (c) selecting a natural zeolite such as the sodium form of Clinoptilolite, Chabazite, Phillipsite, Modenite and Gismondine; (d) calculating the dimensions of the modular canister(s) to be used; and (e) estimating the time at which the system will be exhausted.

This application claims the benefit of U.S. Provisional Application No. 60/380,866, filed May 17, 2002, which is herein incorporated by reference in its entirety.

### FIELD OF THE INVENTION

The present invention relates generally to wastewater treatment and more particularly, to a system and method for removing heavy metals from wastewater, including a method for designing a wastewater treatment system that includes a natural zeolite column or columns.

### BACKGROUND OF THE INVENTION

Zeolites are porous crystalline aluminosilicates which comprise assemblies of SiO₄ and AlO₄ tetrahydra joined together through the sharing of oxygen atoms. More than 150 synthetic zeolite types are known. More than 40 natural zeolites have been found since the discovery of stilbite. Commercially feasible deposits of zeolites have been discovered in Australia, Bulgaria, Canada, Cuba, Georgia, Greece, Hungary, Italy, Japan, Mexico, Romania, Russia, Serbia, Slovakia, Turkey, Ukraine and the United States of America. Occurrences of zeolites have been reported in Angola, Argentina, Botswana, Burundi, Chile, Congo, Egypt, Germany, Guatemala, France, Iran, Jordan, Kenya, Korea, Nicaragua, Pakistan, Panama, Philippines, Spain, South African Republic, Tanzania and other countries. See Roque-Malherbe (2001), Applications of natural zeolites in pollution abatement and industry, Handbook of Surfaces and Interfaces of Materials, Volume 5, Ch. 12 (H. S. Nalwa Ed.), Academic Press, NY. The more abundant natural zeolites are Clinoptilolite, Chabazite, Phillipsite, Mordenite and Gismondine. See, Tsisihsvili et al., (1992) Natural Zeolites, Ellis Horwood, NY.

Ionic exchange is perhaps the most useful attribute of natural zeolites. Ionic exchange in natural zeolites has applications in the industrial, agricultural, aquacultural, and environmental sectors. Applications of ionic exchange in natural zeolites started about fifty years ago. Processes for the treatment of municipal and radioactive wastewater were developed. Likewise, agricultural and aquacultural applications of ionic exchanges in natural zeolites were elaborated. Moreover, methods for processing wastewater with high chemical oxygen demand (COD) and for animal nourishment were developed. See, Roque-Malherbe (2001) supra.

Loizidou and Townsend noted that both Ferrierite and Mordenite have a lower exchange capacity for lead than natural clinoptilolite. See, Loisidou and Townsend 1987. Different processes for the removal of heavy metals from wastewater effluents were tested using natural Clinoptilolite and Chabazite. See, Zaid Ali Al Rashdan, “Investigation of Natural Zeolitic Tuffs on their Ability for Sewage Cleaning Purposes” pp. 60-107, Oldenburg University, dissertation 2000 at http://docserver.bis.uni-oldenburg.de/publikationei/dissertation/2000/rasunt00/pdf/kap05.pdf. Natural Clinoptilolite, pretreated with NaCl solution, added directly to a solution volume in a batch reactor system to remove heavy metals from wastewater exhibited a selectivity sequence as follows: Pb²⁺, ≈Ba²⁺, >>Cu²⁺, Zn²⁺, Cd²⁺, See, M. J. Semmens et al., “The selectivity of Clinoptilolite for certain heavy metals” in Natural Zeolites: Occurrence, Properties, Use, L. B. Sand et al., eds., Pergamon Press, Elmsford, N.Y. pp. 517-526 (1978). The recovery of lead from wastewater can also be performed by adding powdered zeolite bearing rock directly to wastewater. See, M. Pansini, Natural Zeolites as cation exchangers for environment protection, Mineralium Deposita 31:563-575 (1996). When Na-Phillipsite, Na-Chabazite and K-Phillipsite, were compared in a fixed bed system for their potential ability to remove lead from large amounts of wastewater, Na-Phillipsite showed a higher ionic exchange capacity for lead. See Pansini 1996. In fixed bed experiments, Na-Chabazite showed a higher selectivity for Cd²⁺, than Na-Phillipsite. See C. Colella, Ion exchange equilibria in zeolite minerals, Mineralium Deposita, 31: 554-562 (1996).

Clinoptilolite and Chabazite are selective to heavy metals, especially to Pb²⁺ and Cd²⁺. More specifically, Clinoptilolite is efficient in the elimination of Cd²⁺, Co²⁺, Cr³⁺, Cu²⁺, Hg²⁺, Ni²⁺, Pb²⁺ and Zn²⁺ and Chabacite is efficient in the removal of Cr²⁺, Cd²⁺, Pb²⁺, Fe²⁺ and Mn^{2+.} See, Tsisihsvili et al., (1992), supra; Pansini, Mineralium Deposita 31: 563-575 (1996); Roque-Malherbe (2001), supra. Phillipsite, Mordenite and Gismondine are additional natural zeolites for the removal of heavy metals from wastewater by ionic exchange that have potential importance in this field are. Id.

Ionic exchange in zeolites is a complicated phenomenon involving two particles: the extra-framework charge balance cation, which is present in the zeolite, and the cation, which is dissolved in solution. The ion exchange reaction in zeolites is described by Tsisihsvili et al., (1992), which is incorporated herein by reference.

Ionic exchange of the heavy metal cations to zeolite in a fixed bed only occurs in a particular region of the bed, known as the mass transfer zone (MTZ); The MTZ moves through the bed.

FIG. 1 is a plot of the concentration profiled of exchanged cation in the fluid phase as a function of distance along the ionic exchanger bed. In practice, it has been difficult to follow the progress of MTZ inside a column packed with ionic exchanger because it has been difficult to make meaningful measurements of parameters other than temperature. Measuring the concentration of exchanged cation in the fluid as it leaves the fixed bed is not a desirable method of determining column saturation because it means that breakthrough has occurred.

Upstream of the profile, the ionic exchanger is saturated (i.e., in equilibrium) with the exchanged cation. Downstream of the profile, the ionic exchanger is free of exchanged cation. The leading point of the wave is zero if the ionic exchanger is initially completely free of exchanged cation. Before the cation-containing solution is applied to the bed, no part of the bed is saturated. As the wave moves down the bed, the bed is almost saturated for a distance I (Equilibrium Zone), but is still clean at III (unused Zone). Little ionic exchange occurs beyond III, and the ionic exchanger is still unused. The MTZ is where ionic exchange takes place is the region between I and III. The concentration of the exchanged cation on the ionic exchanger is related to the concentration of exchanged cation in the Fed volume by the thermodynamic equilibrium. Those of skill in the art have noted that it is difficult to determine where MTZ begins and ends. See, http://www.separationprocesses.com/Adsorption/Main Set5.htm. The breakthrough point occurs when the wave has moved through the bed and the leading point of the MTZ just reaches the end of the bed. As breakthrough continues, the concentration of the exchanged cation in the effluent increases gradually; when this has occurred no more ionic exchange can take place in the bed.

A plot of the ratio of outlet solute concentration to inlet solute concentration in the fluid as a function of time from the start of flow is shown in FIG. 2. The S-shaped curve is called the breakthrough curve. The steepness of the breakthrough curve determines the extent to which the capacity of an ionic exchange bed can be utilized. Thus, the shape of the curve is very important in determining the length of the ionic exchange bed. In actual practice, the steepness of the concentration profiles can increase or decrease, depending on the type of ionic exchange isotherm involved.

Ionic exchange in zeolites is a complicated phenomenon involving two cationic particles; namely the extra-framework charge balance cation present in the zeolite and the cation dissolved in solution. The ion exchange reaction in zeolites has been described by Tsisihsvili et al., 1992; and Roque-Malherbe, 2001:

z_{B}A^{zA+}+BZ [symbol] AZ+z_{A}B^{zB+} (Equation 1)

In Equation 1, z_{A}+ and z_{B}+ are the charges of the cations of the atoms A and B, respectively; A^{zA+} and B^{zB+} denote the cations of atoms A and B, respectively, in solution; and AZ and BZ are the cations of atoms A and B, respectively, in the zeolite. The Total Cation Exchange Capacity (TCEC) of a zeolite monocrystal is a function of the framework Si/Al relation. A numerical relationship is determined between (i) the total exchange capacity in: mequiv/g (TCEC); and (ii) the number of Al atoms per framework unit cell (N^{Al}). See, Roque-Malherbe, 2001, which is incorporated by reference herein in its entirety. This relationship is presented in the following equation:

TCEC=[(N^{Al}/N_{Av})/(ρV_{c})],

where: N_{Av} is the Avogadro number; ρ is the zeolite crystal density; and V_{c} is the volume of the framework unit cell. The relation follows from: N^{Al}/N_{Av}=total number of equivalents of exchangeable cations per unit cell and (ρV_{c})=mass of the unit cell. It is possible to estimate the TCEC of a natural zeolite sample, using the TCEC of a zeolite monocrystal. The TCEC of the zeolite monocrystal is the same as the TCEC of a pure natural zeolite (i.e., a natural zeolite with 100 wt. % of zeolite phase) and the natural zeolite mineralogical phase composition. See, R. Roque-Malherbe, et al., Study of Pb²⁺, Ni²⁺, Co²⁺ and Cu²⁺ removal from water Solutions by dynamic ionic exchange, in Na-clinoptilolite Beds, Zeolites (P. Misaelides Ed.) 7^{th} International Conference on the Occurrence, Properties and Use of Natural Zeolites, Thessaloniki, Greece, Jun. 3-7, 2002, Abstracts pp. 316-317.

The idea that differential and integral heats of ion-exchange are analogous to the differential and integral heats of ionic exchange was described by Roque-Malherbe et al., (1987), Calorimetric measurement of ion exchange heats in homoinic heulandite and mordenite, J. Thermal Analysis 32:949-951, which presented the following expression for the differential heat of ion-exchange:

Q_{d}=ΔH−DH (Equation 2)

where the term ΔH={EB−EA(zB/zA)}, is the heat evolved in the zeolite; and DH={EB−EA(zB/zA)} is the heat evolved in the solution during the cationic exchange process (Equation 1). EA and EB are the partial molar internal energies of cations A^{zA+} and B^{zB+} in the zeolite and EA and EB are the partial molar internal energies of cations A^{zA+} and B^{zB+} in solution and (zA+) and (zB+) are the charges of the cations of the atoms A and B respectively. So, if the differential heat of ion exchange (Qd) is >0, then the process is exothermic and cation A^{zA+} is selectively exchanged in relation to cation B^{zB+}.

Kinetic aspects are important in the application of ionic exchange in zeolites. It is in generally recognized that the ionic exchange process in zeolites is characterized by three stages: (a) interdiffusion in the adhered liquid thin layer; (b) an intermediate step, where interdiffusion in the liquid thin layer and crystalline interdiffusion are both present; and (c) interdiffusion of A and B in the zeolite crystals. See, Tsisihsvili et al., 1992; Roque-Malherbe, 2001.

The output rate of the cation of atom B from the zeolite grain during the interdiffusion in the adhered liquid thin layer can be calculated using the following equation:

r=−RC (Equation 3)

where, C, is the concentration of the cation of atom B in the interface zeolite grain-adhered liquid thin layer; r=dC/dt; and R is the rate constant of the interdiffusion in the adhered liquid thin layer. The kinetic of the interdiffusion in the adhered liquid thin layer is described, therefore, by the following Equation 3a:

U(t)={Q_{B}(0)−Q_{B}(t))/(Q_{B}(0)−Q_{B}(∞)}=Q_{A}(t)/Q_{A}(∞)=1−exp[−Rt]≅Rt (Equation 3a)

where; Q_{B}(0) is the initial magnitude of cation of atom B in the zeolite, Q_{B}(t) is the magnitude of the cation of atom B at time: t, and Q_{B}(∞) is the equilibrium magnitude. Q_{A}(t) is the magnitude of the cation of atom A in the zeolite at time: t, and Q_{A}(∞) is the equilibrium magnitude and R is the slope of the curve, U(t) versus time.

The intra-crystalline diffusion kinetics could be approximately described using the following equations:

U(t)≅[1−exp(−Bt)]^{1/2} (Equation 4)

B=D^{I}π²/a² (Equation 4a)

where, D^{I} is the interdiffusion coefficient and, a is the effective radius of the zeolite crystals. The values reported for the interdiffusion coefficients of cations in natural zeolites are fundamentally from around 10⁻⁷ cm²/s to about 10⁻¹² cm²/s. The factors that basically affect the velocity of cationic exchange are: (a) the charge of the interdiffusing cations; (b) the zeolite structure; and (c) the cationic radius. See, Roque-Malherbe, 2001.

The zeolite bed during dynamic exchange in the PFIEBR is divided in three zones, which are depicted in FIG. 1. Zone I is the equilibrium zone, where the ionic exchange reaction is in equilibrium and therefore the zeolite is saturated with cations of the atom A. Zone II is the Mass Transfer Zone (MTZ) with a length, Dₒ, where the dynamic exchange is occurring. Zone III is the unused zone.

As described by Drost, the contact time of the fluid passing though the PFIEBR is

τ=V_{B}/F (Equation 5)

where, V_{B}=α; V is the volume of the empty bed, where V_{B} is the bed volume and α is the fraction of free volume in the bed. See, R. Droste, Theory and practice of waste and wastewater treatment, John Wiley and Sons, NY, 1997.

One method for calculating the length of the Mass Transference Zone (MTZ), Dₒ, is defined by the following Equation 6 (See FIG. 2):

Dₒ=2D{(V_{b}−Vₑ)/(V_{b}+Vₑ)} (Equation 6)

See Pansini (1996). Pansini (1996) also described the column breakthrough capacity, B_{C}, the column saturation capacity, S_{C}, an the column efficiency, E, of the PFIEBR, which are calculated with the following equations (See FIG. 2):

B_{C}={[CₒVₑ]/M} (Equation 7)

S_{C}={[CₒV_{b}]/M} (Equation 8)

E=B_{C}/S_{C} (Equation 9)

The mass balance equation for the PFIEBR is that described by Droste (1997):

IN−OUT=ACCUMULATION (Equation 10)

This means that the transported cations, (A^{zA+}, See Equation 1), into the reactor (IN) minus the transported cations outside the reactor {OUT} is equal to the accumulation of cations of the atom A (AZ, See Equation 1) in the zeolite bed {ACCUMULATION}. The zeolite bed in the PFIEBR could be divided in three zones: I the equilibrium zone, II Mass Transfer Zone (MTZ) with a length, Dₒ and III the unused zone. FIG. 1 shows the concentration profile {C(x)} of A^{zA+} in an aqueous solution through the PFIEBR. The accumulation rate of cations of atom A in the zeolite grains could be, in general, calculated using the following relationship, (Droste, 1997):

r_{A}=kC(x)ⁿ (Equation 11)

where r_{A} [mass/volume/time] is the rate of the reaction producing the accumulation of the cations of atom A in the zeolite; and k is the rate coefficient.

Utilizing the following Equation 12, (See FIG. 1):

F_{A}(x)=C(x)F (Equation 12)

it is possible to express the mass balance equation numerically using Equation 13 as follows (See FIG. 1):

F_{A}(x)−{F_{A}(x)+dF_{A}(x)}=r_{A}dV=r_{A}Sdx (Equation 13)

FIG. 1 is a graph showing the concentration profile, C(x), of a fluid flowing through a plug flow ionic exchange bed reactor (PFIEBR) as a function of the distance traveled, x, within the PFIEBR. In the graph, the overall length of the PFIEBR is represented by distance D. F(x) is the product of F and C(x), where F is the flow rate of the wastewater entering the PFIEBR. The zeolite bed during dynamic exchange in the PFIEBR can be divided in three zones as depicted in FIG. 1. Zone I is the equilibrium zone in which the ionic exchange reaction is in equilibrium. In Zone I, the zeolite is saturated with cations of the atom A. Zone II is the mass transfer zone (MTZ), in which the dynamic exchange is occurring. Zone II has a length, Dₒ. Zone III is the unused zone.

### SUMMARY OF THE INVENTION

The present invention is directed to a method and system for removing heavy metals from wastewater using a natural zeolite ionic exchange bed that has a mass transfer zone sized based on the hydraulic loading of the wastewater. The method and system can include (a) analyzing the wastewater to be treated to determine and quantify the contained heavy metals; (b) determining the wastewater flow rate; (c) selecting a natural zeolite such as the sodium form of Clinoptilolite, Chabazite, Phillipsite, Modenite and Gismondine;(d) calculating the dimensions of the modular canister(s) to be used; and (e) estimating the time at which the system will be exhausted. Dynamic ionic exchange in natural zeolite columns is used, in which Modular Canister Ionic Exchange Bed Reactors are designed for specific applications to remove heavy metal cations from wastewater. Preferably, the mass transfer zone has a distance that is about 125 to about 130 times the hydraulic loading.

The method and system may use at least one Plug Flow Ionic Exchange Bed Reactor (PFIEBR) filled with a well-characterized Na-Clinoptilolite, which can remove Pb²⁺, Ni²⁺, Co²⁺, and Cu²⁺ through a dynamic ionic exchange in the PFIEBR(s). In one preferred method and system of the invention, Pb²⁺ is more selectively exchanged than Ni²⁺, Co²⁺, and Cu²⁺, where the selectivity increases in the order of Ni²⁺<Co²⁺<Cu²⁺<Pb²⁺. In a preferred embodiment, a contact time, τ, greater than 60 seconds is required for an effective operation of the PFIEBR. Also, a zeolite grain size (φ) of ≦0.1 d may be required for adequate functioning of the PFIEBR. PFIEBRs consisting of sodium natural Clinoptilolite ionic exchange columns are used to measure the removal of Pb²⁺, Ni²⁺, Co²⁺ and Cu²⁺ from water solutions to determine the parameters of a system including PFIEBR. An empirical equation, based on the measured parameters, is used along with some operational parameters of the PFIEBR to calculate the specifications of a Modular Canister Ionic Exchange Bed Reactor(s) (MCIEBR). One or a set of MCIEBRs are filled with a well characterized natural zeolite, such as Clinoptilolite, Chabazite, Mordenite, Phillipsite or Gismondine in sodium form, that is customized for a specific application or a variety of applications.

### BRIEF DESCRIPTION OF THE DRAWINGS

The figures merely represent possible embodiments of the present invention. The figures are not intended to limit the invention to any of the preferred embodiments described in the drawings. They show:

FIG. 1 is a diagrammatic representation of the Plug Flow Ionic Exchange Bed Reactor (PFIEBR). D is the column length; Dₒ is the MTZ length; C(x) is the concentration profile; F(x)=FC(x) profile where F, flow rate. I indicates the equilibrium zone, II is the Mass Transfer Zone (MTZ) with a length Dₒ; and III is the unused zone.

FIG. 2 is a graph illustrating a theoretic breakthrough curve resulting from the operation of the PFIEBR, where Cₒ is the initial concentration; Cₑ is the breakthrough concentration; Vₑ is the fed volume of the aqueous solution of A{z_{A}+} to breakthrough; and V_{b} is the fed volume to saturation.

FIG. 3 is a photograph of a basic modular canister set-up comprising the following parts: (A) inlet valve; (B) pump; (C) column valve(s); (D) ionic exchange column; and (E) outlet valve.

FIG. 4 is a diagram of a basic modular canister set-up comprising of the following parts: (A) valves (inlet=A1, column=A2, outlet [not shown]); (B) Pump; (C) Elbow joint(s); (D) ionic exchange column or Canister; (E) Tee joint; and (F) Union.

FIGS. 5A, 5B, and 5C show the X-ray diffraction profiles (counts per second (CPS) versus 2θ) of the following natural zeolite samples: FIG. 5A is of SW (from Sweetwater, Wyo., USA); FIG. 5B is of GR (from Dzegvi, Ga.) and FIG. 5C is of HC (from Castillas, Province of Havana, Cuba).

FIGS. 6A and 6B are graphs showing the Experimental Breakthrough curves obtained during the operation of the tested PFIEBR filled with a mass of M=1.5 grams of Na-Clinoptilolite having a grain size (φ) of 0.6 mm to 0.8 mm (FIG. 6A) and a grain size (φ) of 0.8 mm to 2.0 mm (FIG. 6B). The volumetric flow rate (F) was 0.8 cm³/min of aqueous solution of Pb(NO₃)₂ with an initial concentration, Cₒ, of 0.45 mg/cm³ of Pb²⁺.

FIGS. 7A and 7B are graphs showing the Experimental Breakthrough curves obtained during the operation of the tested PFIEBR filled with a mass of M=1.5 grams of Na-Clinoptilolite having a grain size (φ) of 0.6 mm to 0.8 mm (FIG. 7A) and a grain size (φ) of 0.8 mm to 2.0 mm (FIG. 7B). The volumetric flow rate (F) was 0.32 cm³/min (FIG. 7A) and 0.8 cm³/min (FIG. 7B) of aqueous solution of Ni(NO₃)₂.6H₂O with an initial concentration 0.65 mg/cm³ of Ni²⁺.

FIGS. 8A and 8B are graphs showing the Experimental Breakthrough curves obtained during the performance of the tested PFIEBR loaded with 1.5 g of Na-Clinoptilolite with a grain size (φ) of 0.6 mm to 0.8 mm. The volumetric flow rate (F) of the aqueous solution of Cu(NO₃)₂.2.5H₂O with an initial concentration 0.35 mg/cm³ of Cu²⁺ were 0.32 cm³/min (FIG. 8A) and 0.8 cm³/min (FIG. 8B).

FIG. 9 is a graph showing the Experimental Breakthrough curve obtained during the operation of the tested bed reactor filled with 1.5 g of Na-Clinoptilolite, with a grain size (φ) of 0.6 mm to 0.8 mm. The volumetric flow rate (F) was 0.32 cm³/min of aqueous solution of Co(NO₃)₂.6H₂O with an initial concentration 0.40 mg/cm³ of Co²⁺.

### DETAILED DESCRIPTION OF THE INVENTION

The term “heavy metal(s)” as used herein refers to heavy metal cations, including but not limited to Pb²⁺, Cd²⁺, Co²⁺, Cr²⁺, Cu²⁺, Hg²⁺, Ni²⁺, Zn²⁺, Fe²⁺ and Mn²⁺. The operation of the PFIEBR is based on the development of a method that utilizes a phenomenological description of dynamic ionic exchange in zeolite beds. By considering the interdiffusion in the adhered liquid thin layer as the rate determining step, it is possible to consider that n=1 in Equation 11, since for this transport process the diffusion rate (k) is proportional to concentration. This approach is based what the Examples show to be true, that the rate determining process, during the dynamic ionic exchange in zeolite columns, is the diffusion in the zeolite secondary porosity, i.e., the transport process in the macro and mesoporosity formed by the matrix inserted between zeolite crystals; and that the rate determining factor is not the diffusion in the zeolite primary porosity, i.e., in the cavities and channels which constitute the zeolite framework.

The terms in Equation 13 are simplified using Equation 11, with n=1, and Equation 12, to obtain the following Equations:

−FdC(x)=SkC(x)dx (Equation 14)

−{dC(x)/C(x)}={kS/F}dx (Equation 14a)

The Hydraulic Load, W is defined as:

W={F/S} (Equation 15)

This allows Equation 14 to be rewritten as the following Equation 16:

−{dC(x)/C(x)}={k/W}dx (Equation 16)

Equation 16 can be integrated in the MTZ as follows:

Cₑ Dₒ

∫−{dC(x)/C(x)}=∫dx

Cₒ 0 (Equation 17)

This results in the following Equation 18:

Dₒ={W/k} ln {Cₒ/Cₑ} (Equation 18)

The following Equation 19 is obtained by combining Equations 6 and 18:

2D{(V_{b}−Vₑ)/(V_{b}+Vₑ)}={W/k} ln {Cₒ/Cₑ} (Equation 19)

Using data obtained from the experimental Breakthrough Curves for the dynamic ionic exchange in a zeolite bed placed in a Plug Flow Ionic Exchange Bed Reactor (PFIEBR), such as the data in the Examples, Equation 19 is used to calculate the kinetic parameters defining the system and process of the present invention.

As stated above, DH={E_{B}−E_{A}(z_{B}/z_{A})}, but DH≈{H_{B}−H_{A}(z_{B}/z_{A})} where H_{A} and H_{B} are the hydration heats of the cations involved in the cation exchange reaction (Equation 1). Consequently, the sign of Q_{d}, namely, the differential heat of ion-exchange, will be determined in general by the difference between the hydration heats using methods know in the art. See, Roque-Malherbe, et al., 1987

One aspect of the method and system of the present invention utilizes the recognition that the selectivity of divalent cations is largely controlled by their hydration heats, more so than by their cation-framework interaction. As a result, natural zeolites have a tendency to favor the exchange of cations having a lower hydration energy. For example, lead is favored over cooper nickel or cobalt. In one aspect of the present invention, the recognition of the dominant effect of hydration heats on divalent cation selectivity enables one object of the present invention to provide Modular Canister Ionic Exchange Bed Reactors for the removal of heavy metals from wastewater along with the guidance provided by calculations utilizing Equation 18.

The rate coefficient parameter (k) is determined utilizing Equation 19 (See Example 4) for the dynamic ionic exchange of the least or a less selectively exchanged cation; that is k¹, enables the determination of the longest length of the MTZ. A determination of the longest MTZ length for the particular wastewater heavy metal conditions at hand, provides one key component of the design for the Modular Canister Ionic Exchange Bed Reactors having a natural zeolite bed as ionic exchanger, which function properly to treat wastewater containing a less selectively exchanged cation.

The basic premise is as follows: because the ionic exchange bed is calculated and designed to efficiently treat wastewater containing the least or less selectively exchanged cation, then that same ionic exchange bed can be used to efficiently treat wastewater containing all other heavy metal cations that are selectively exchanged more readily.

In the practical exploitation of ionic exchange bed reactors, Cₒ/Cₑ≈100. Accordingly, using Equation 18, it is possible to obtain the following Equation 20:

Dₒ≈{W/k¹} ln {100}=CW (Equation 20)

where C will be in a range of values Cₘᵢₙ<C<Cₘₐₓ which are determined.

To provide (a) the instant method for designing a Modular Canister Ionic Exchange Bed Reactor or a set of Modular Canister Ionic Exchange Bed Reactors; (b) the instant design of a Modular Canister Ionic Exchange Bed Reactor or a set of Modular Canister Ionic Exchange Bed Reactors; and (c) the instant system for removing heavy metals from wastewater, the following is used: (i) an empirical equation, that is obtained from Equation 20; (ii) a determination of the total cation exchange capacity of the natural zeolite to be used; and (iii) the operational parameters of the PFIEBR. The operational parameters of the PFIEBR include, but are not limited to: the minimum contact time (τ); and the relationship between the internal diameter of the ionic exchange column (d) and the natural zeolite particle diameter (φ), which is estimated.

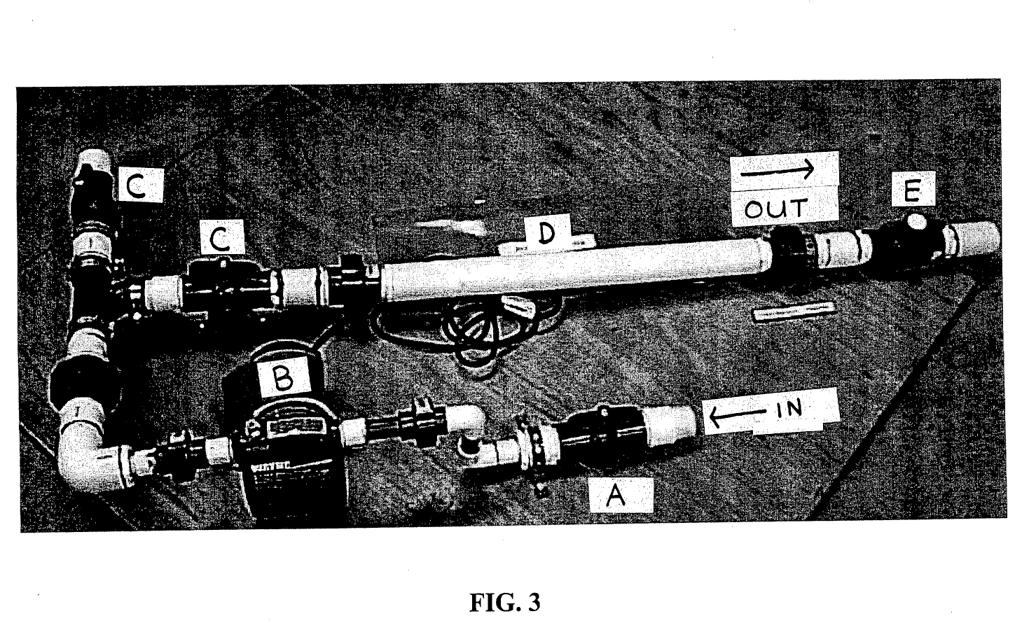

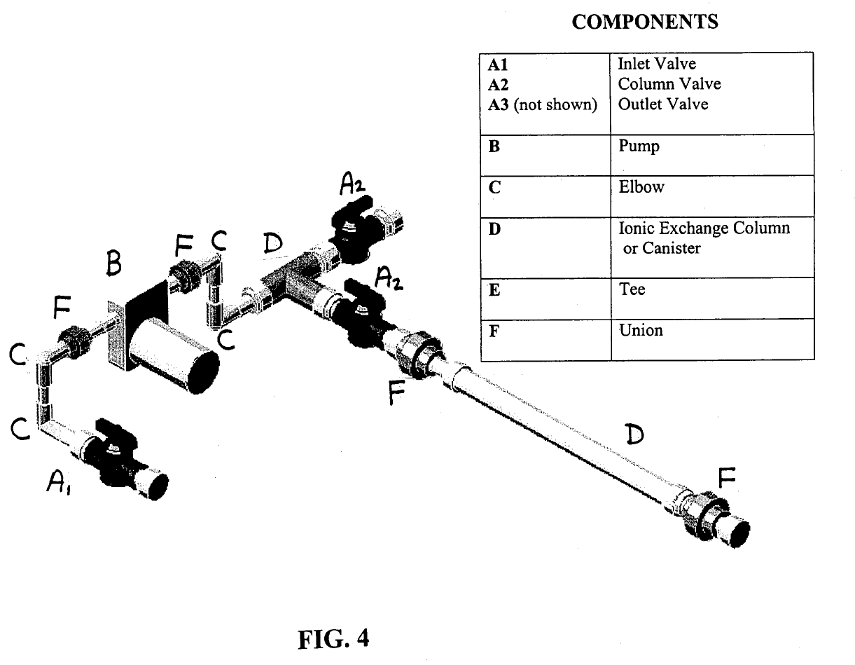

The method and system of the present invention is distinguished by its utilization of one or a group of Modular Canister Ionic Exchange Bed Reactors packed with a well characterized zeolite. Such well characterized zeolites include, but are not limited to Clinoptilolite, Chabazite, Phillipsite, Mordenite and Gismondine, each in sodium form. The packed bed reactor is calculated for the specific application and manufactured for the specific use. In one embodiment of the present invention, the wastewater cleaning system set-up is comprised of at least one canister or ionic exchange column, flow meters, pumps, valves and tubing. The system can be set up at the specific site where wastewater is to be cleaned. Examples of such a system are shown in FIGS. 3 and 4.

After the completion of a work cycle when the ionic exchange column or canister is saturated with heavy metals, the canister or column is substituted with a fresh zeolite-containing column or canister. The exhausted or spent zeolite from the used canister/column is saturated with heavy metals; that zeolite is then either disposed of or recycled. Finally, the canister or column is cleaned and refilled with fresh sodium natural zeolite so that it may be used again.

One embodiment of the present invention relates to the development of a phenomenological picture of dynamic ionic exchange in zeolite beds, which allows the calculation of the kinetic parameter(s) significant for the design of a Modular Canister Ionic Exchange Bed Reactor (MCIEBR). The MCIEBR can be configured for a specific use. In another embodiment of the invention, some of the parameters that describe the operation of PFIEBR are measured experimentally to develop a system that provides a process and system for the removal of heavy metal removal from wastewater.

One embodiment of the method and system of the present invention, comprises the following phases: (a) quantifying the heavy metals in the wastewater to be treated; (b) calculating the wastewater flow; (c) selecting a natural zeolite to be packed in the reactor or reactors; (d) calculating the dimensions of the modular canister or canisters to be used; (e) determining the saturation capacity of the reactor or reactors; and (f) manufacturing the canisters, preferably the ionic exchange columns having said dimensions and the selected natural zeolite. In a preferred embodiment, the system is installed at the location to be treated. In another embodiment of the present invention, the reactor or reactors are replaced after one operation cycle; for example, the old canister(s) are replaced with fresh one(s). In a further embodiment of the present invention, the removed canister(s) containing saturated zeolite are recycled by removing the saturated zeolite, cleaning the canister(s), refilling the canister(s) with fresh zeolite. In this way, the old canister can be used again in another operation cycle.

In another embodiment of the present invention, a method for removing heavy metal cations from wastewater is provided comprising the following steps:

(a) analyzing the wastewater to be treated to determine and quantify the contained heavy metals; (b) determining the wastewater flow rate; (c) selecting a natural zeolite selected from the group consisting of the sodium form of Clinoptilolite, Chabazite, Phillipsite, Modenite and Gismondine, said selecting based on cost, availability, and quality of said zeolite; (d) calculating the dimensions of the at least one modular canister to be used; and (e) estimating the time at which the system will be exhausted, said estimating comprising consideration of factors, said factors comprising: the zeolite TCEC, the concentration of the heavy metals contained in the wastewater; and the wastewater flow rate.

### EXAMPLES 1-4

### Dynamic Ionic Exchange of Pb²⁺, Ni²⁺, Co²⁺ and Cu²⁺ in Na-Clinoptilolite Beds

### Example 1

### Clinoptilolite Characterization and Modification

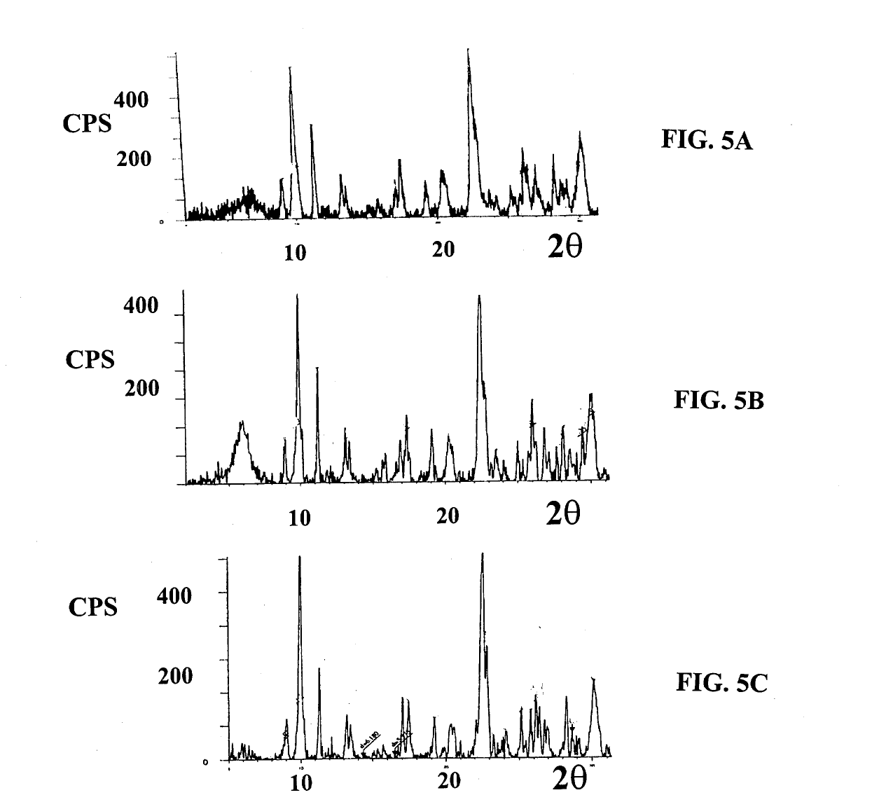

FIGS. 5A, 5B and 5C are X-ray diffraction profiles (counts per second (CPS) versus 2θ) for three natural zeolites, namely: Sample SW (FIG. 5A); Sample GR (FIG. 5B); and Sample HC (FIG. 5C). Sample SW, was mined in the Sweetwater deposit located in the State of Wyoming, in the United States of America. Sample SW was provided by ZeoponiX Inc., Louisville, Colo., USA. Sample HC and Sample GR are two very well characterized Clinoptilolite standard samples. Sample HC was obtained from Castillas, Province of Havana, Cuba, and Sample GR was obtained from Dzegvi, Ga. FIG. 5A represents the X-ray diffraction (XRD) pattern of Sample SW. This XRD profile was compared with the XRD profiles of Sample HC (FIG. 5C) and Sample GR (FIG. 5B).

The XRD patterns for Sample HC and Sample GR are very similar to the XRD profile of Sample SW. The chemical and mineralogical composition of Samples HC and GR are reported in Tables 1 and 2. The X-ray diffractograms were obtained in a Siemens D5000 X-ray Diffractometer, in vertical set up: θ-2θ geometry, using a Cooper K_{α} radiation source (λ=15.4 nm), Ni filter and Graphite monochromator.

TABLE 1
Chemical composition (in oxide weight %) of two natural Clinoptilolite
samples (HC and GR) used as standards in the instant specification.

| | SiO₂ | Al₂O₃ | Fe₂O₃ | CaO | MgO | Na₂O | K₂O | H₂O |
|---|---|---|---|---|---|---|---|---|
| HC | 66.8 | 13.1 | 1.3 | 3.2 | 1.2 | 0.6 | 1.9 | 12.1 |
| GR | 62.4 | 12.0 | 2.9 | 4.1 | 1.8 | 2.0 | 1.2 | 14.1 |

Note:
Sample identification (label: deposit name, location).
HC: Castillas, Province of Havana, Cuba and
GR: Dzegvi, Georgia.
The error in the chemical composition is ± 0.2%

TABLE 2
Mineralogical composition (in weight %) of a pair of natural
Clinoptilolite samples adopted in the present patent as standards

| Sample | Clinoptilolite | Others* |
|---|---|---|
| HC | 85 | 15 |
| GR | 85 | 15 |

Note:
The error in the mineralogical composition is ±5%.
*Others = Montmorillonite (2-10 wt. %); Quartz (1-5 wt. %); Calcite (1-6 wt %); Feldspars (0-1 wt. %); Magnetite (0-1 wt. %); and volcanic glass (3-6 wt %).

The natural zeolite Sample SW is analyzed in homoinic form, which means that the zeolite contains a prevalent cation exchanged in the cationic sites of its channels and cavities. Sample SW was refluxed (at 373° K) five times, for 4 hours each period, in a 2 Molar solution of NaCl to produce sample Na—SW, i.e., the Na-Clinoptilolite ionic exchanger.

The direct experimental evaluation of the Total Cation Exchange Capacity TCEC of the SW natural Clinoptilolite sample, which is referred to as TCEC(SW-d), was carried out using the following methodology: 1 g of the natural zeolite Sample SW was refluxed (at 373° K) once for 6 hours in 1 liter of a 2 M solution of NH₄Cl to produce a homoionic sample NH₄—SW. The degree of exchange of Na⁺, K⁺, Ca²⁺ and Mg²⁺ in the NH₄Cl solution was measured by Atomic Absorption spectrometry, using a Perkin Elmer 3300 AA spectrometer, equipped with Perkin Elmer lamps (Table 3). To perform the elemental chemical analysis of a zeolite sample, the sample was analyzed using a JEOL Model 5800LV electron microscope having an Energy Dispersive X-ray Analysis accessory, EDAX-DX-4, with the acceleration of the electron beam of 20 kV. The results for the Na—CSW sample are shown in Table 4. The Na—CSW sample grains 3 mm) were glued with colloid to the sample-holder and were coated. As a result, it was determined that the degree of exchange of Na was around 80% and the silicon aluminum rate, Si/Al=4.1.

TABLE 3
Cationic composition and direct TCEC (SW-d) (in mequiv/gram)
of the natural Clinoptilolite Sample SW.

| | Na⁺ | K⁺ | Ca²⁺ | Mg²⁺ | |
|---|---|---|---|---|---|
| | [mequiv/ | [mequiv/ | [mequiv/ | [mequiv/ | TCEC |
| Sample | g] | g] | g] | g] | [mequiv/g] |
| SW | 1.24 | 0.21 | 0.49 | 0.09 | 2.0 |

Note:
The error in the Na⁺, K⁺, Ca²⁺ and Mg²⁺ cationic composition is ± 0.02 mequiv/g and the error in TCEC (SW-d) is ± 0.1 mequiv/g.

TABLE 4
Chemical composition (in weight %) of the Na-CSW sample,
determined by Energy Dispersive X-ray Analysis
in a JEOL Model 5800LV Scanning Electron Microscope.

| Sample | O | Si | Al | Fe | Ca | Mg | Na | K |
|---|---|---|---|---|---|---|---|---|
| Na-CSW | 45.25 | 37.48 | 9.25 | 1.06 | 0.05 | 0.58 | 5.46 | 0.90 |

The mineralogical phase composition of Sample SW was calculated using the X-ray Diffraction data shown in FIG. 5, the data reported in Table 2, which shows that Sample SW has the following composition (in wt %): 90±5% Clinoptilolite and 10±5% others, where the others are Montmorillonite (2-10 wt. %), quartz (1-5 wt. %), calcite (1-6 wt %), feldspars (0-1 wt. %), magnetite (0-1 wt. %) and volcanic glass (3-6 wt %).

It is possible to indirectly evaluate the total cation exchange capacity of Sample SW by employing (a) the sample mineralogical phase composition and (b) the TCEC of a pure Clinoptilolite, which fluctuates between 2.0-2.2 mequiv/g depending on the Si/Al relation of the Clinoptilolite monocrystal. The indirect evaluation of the total cation exchange capacity of Sample SW is conducted as follows: TCEC(SW-i)≈[TCEC of a Clinoptilolite monocrystal]×[sample mineralogical phase composition]=(2.1±0.1)×0.9 mequiv/g=1.9±0.1 mequiv/g.

The direct experimental evaluation of the TCEC of the SW natural Clinoptilolite sample, is carried out using the methods previously described to obtain the measurement of the cationic composition of Sample SW in mequiv/gram of Na⁺, K⁺, Ca²⁺ and Mg²⁺ present in the mineral. The results obtained are reported in Table 3, which shows that the TCEC (SW-d)=2.0±0.1 mequiv/g.

### Example 2

### Role of pH in the Ionic Exchange Process

Table 5 shows the results of the pH measurements of the of the aqueous solutions of Pb(NO₃)₂, Ni(NO₃)₂, Co(NO₃)₂ and Cu(NO₃)₂ with the following concentration: C(Pb²⁺)=0.45 mg/cm³, C(Ni²⁺)=0.65 mg/cm³, C(Co²⁺)=0.40 mg/cm³ and C(Cu²⁺)=0.35 mg/cm³; as well as the pH of these solutions in contact with a Na—CSW powder having a grain size (φ) of 0.1 mm to 0.2 mm and a solution/solid ratio=25 ml of solution/1 gram of zeolite. The temperature of the solutions during the pH measurements was 296.0° K

TABLE 5
Outcome of the pH measurements of the aqueous solutions.

| | | PH |
|---|---|---|
| | pH | [with |
| Cation | [no-zeolite] | zeolite] |
| Pb²⁺ | 5.7 | 6.7 |
| Ni²⁺ | 6.9 | 6.8 |
| Co²⁺ | 6.5 | 6.8 |
| Cu²⁺ | 5.00 | 5.00 |

The hydrolysis of the nitrates of the heavy metals tested here i.e., Pb²⁺, Ni²⁺, Co²⁺ and Cu²⁺ in acid are known to those of skill in the art. In these solutions, therefore, hydronium ions (H₃O)⁺ are also present; hydronium ions are also well exchanged. The exchange systems described in the instant specification, therefore, are in principle ternaries. It may be necessary to take into account the exchange of the hydronium ions; however, the results reported in Table 6 clearly indicate that the exchange of (H₃O)⁺ is negligible and in fact it is possible to consider the system of the present invention to be a binary system in which only two cations are exchanged.

### Example 3

### The Plug Flow Ionic Exchange Bed Reactor

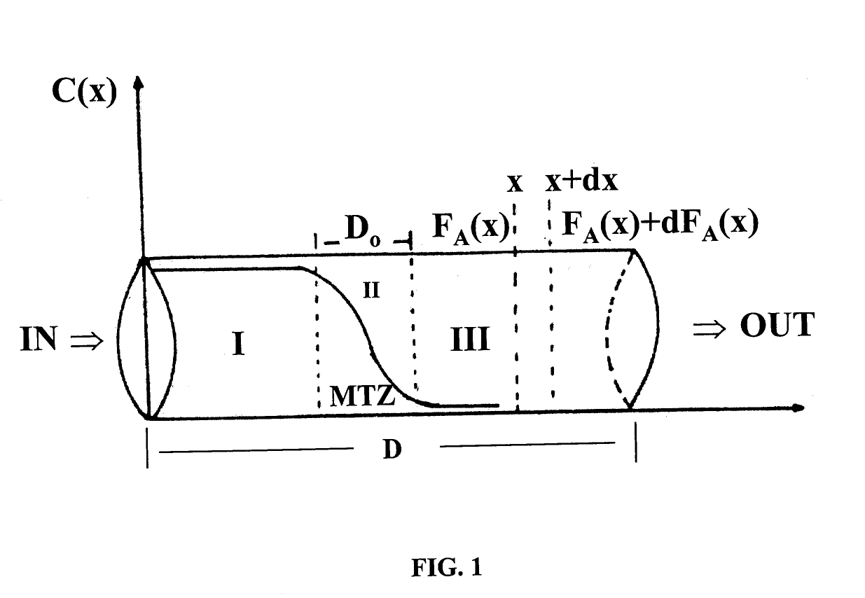

In one embodiment of the method and system of the present invention, the dynamic ionic exchange occurs in a zeolite bed placed in a Plug Flow Ionic Exchange Bed Reactor (PFIEBR). The PFIEBR has a cross sectional area, S, column length, D, and zeolite mass in the bed, M, which is illustrated in FIG. 1. The PFIEBR operates in steady state regime and through it is passing a volumetric flow rate, F {F=(ΔV/Δt)=Volume/time} of an aqueous solution with an initial concentration Cₒ{mass/volume} of cation A^{zA+}.

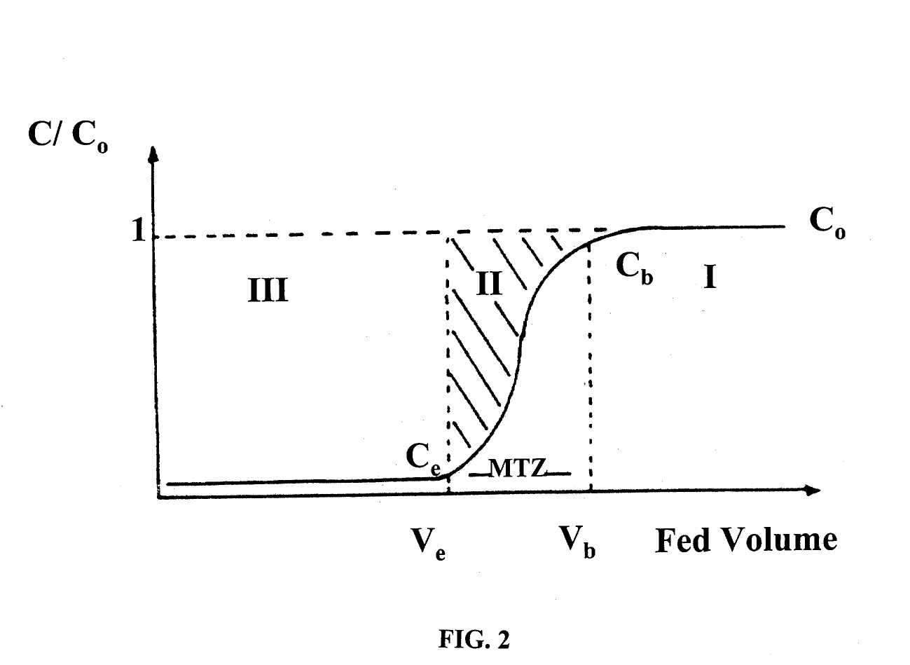

The theoretic breakthrough curve produced from the operation of one embodiment of the PFIEBR of the present invention is represented in FIG. 2, where Cₒ is the initial concentration, Cₑ is the breakthrough concentration, Vₑ is the fed volume, of the aqueous solution of A{z_{A}+} to breakthrough; and V_{b} is the fed volume to saturation.

The experimental operational parameters for the Plug Flow Ionic Exchange Bed Reactor are measured using the following methodology. Disposable cylindrical polystyrene mini-columns (SPECTRUM®), which have an internal diameter (d) of 0.732±0.001 cm (cross section area, S=0.421±0.002 cm²) and a total length of 7 cm, are used to construct the tested Plug Flow Ionic Exchange Bed Reactors. The columns are prepared with a bed length of, D=3.63±0.02 cm, filled with a mass of M=1.50±0.01 g of Na-Clinoptilolite with a grain size (φ) of 0.6 mm to 0.8 mm and a free bed volume, V_{B}≈0.8±0.1 cm³ or a grain size (φ) 0.8 mm to 2.0 mm and a free bed volume, V_{B}≈1.0 ±0.1 cm³.

The following was passed through the constructed Plug Flow Ionic Exchange Bed Reactor: 0.8±0.02 cm3/min of aqueous solutions of Pb(NO3)2, Ni(NO3)2, Co(NO3)2 and Cu(NO3)2 with initial concentrations Co(Pb²⁺)=0.45 mg/cm³, Co(Ni²⁺)=0.65 mg/cm³, Co(Co²⁺)=0.40 mg/cm³ and Co(Cu²⁺)=0.35 mg/cm³ at a volumetric flow rate (F) of 0.32±0.02 cm³/min. The salts employed are pure, per analysis products provided by FISHER.

The flow rate is maintained with the help of a Variable Flow Mini-Pump (Model 3386, Manufactured by the Control Company, TX, USA). The flow rate delivered by the Mini-Pump was calibrated using a 100 cm³ buret and a chronometer. Five calibration tests are carried out for each flow. Wall effects are avoided, because the flow rate is low enough to guarantee a steady flow in the column.

The concentration of Pb²⁺, Ni²⁺, Co²⁺ and Cu²⁺ at the output extremity of the cationic exchange column was measured by Atomic Absorption spectrometry, using a Perkin Elmer 3300 AA spectrometer, equipped with Perkin Elmer hollow cathode lamps. The pH of the Pb²⁺, Ni²⁺, Co²⁺ nitrate water solutions is measured using a Fisher Scientific pH meter Model 910.

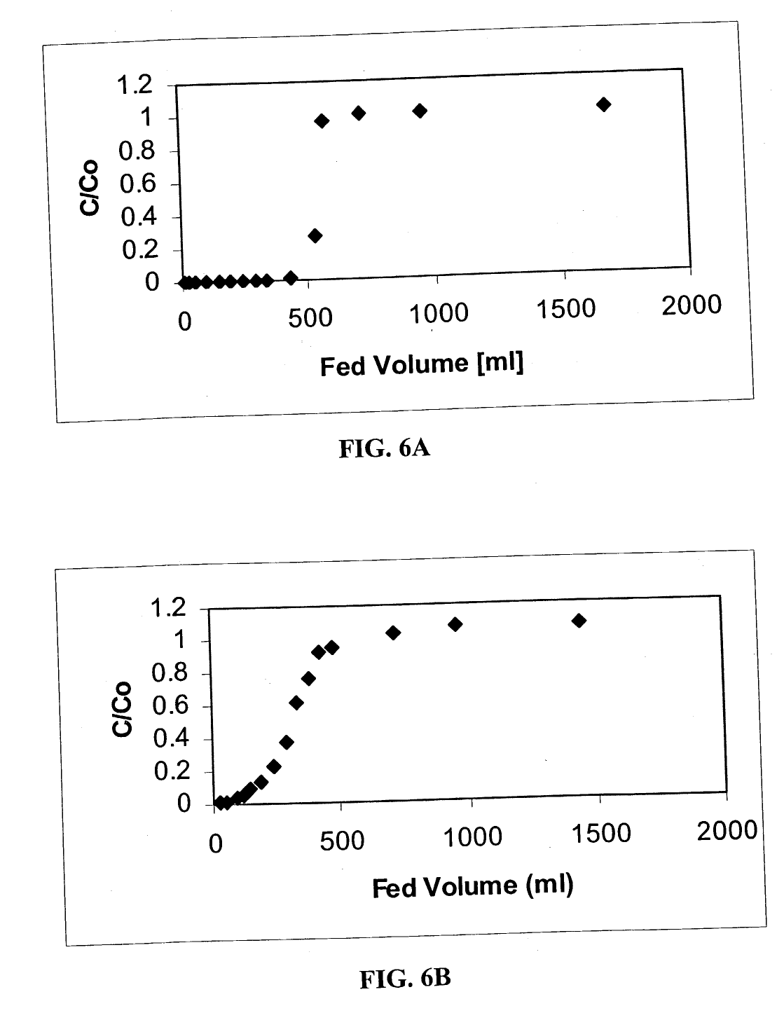

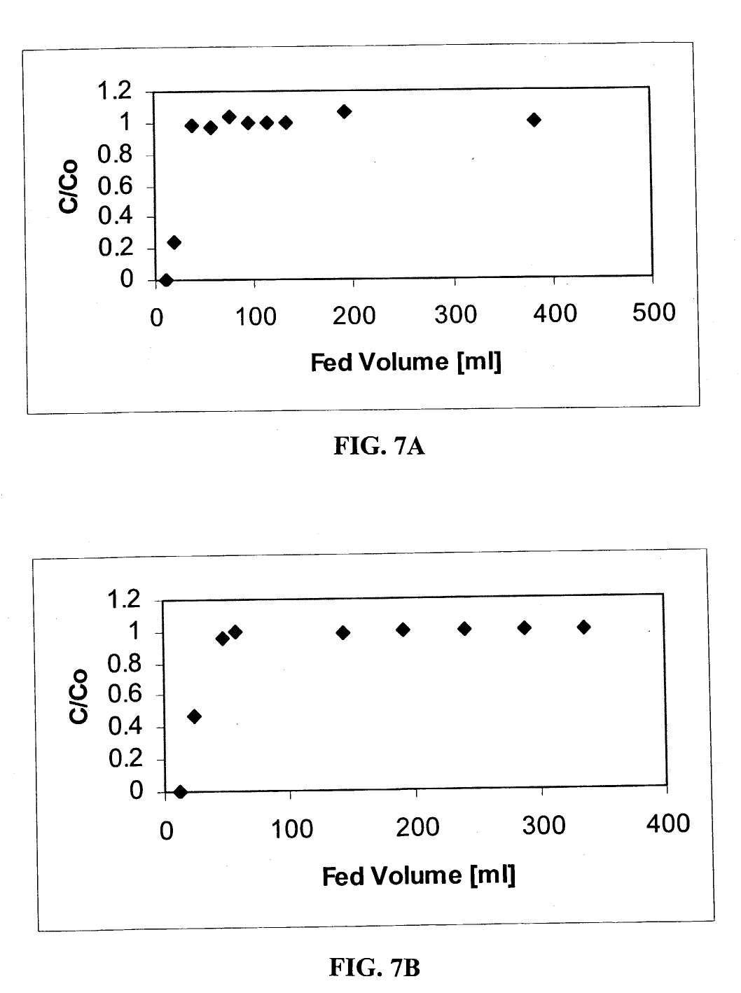

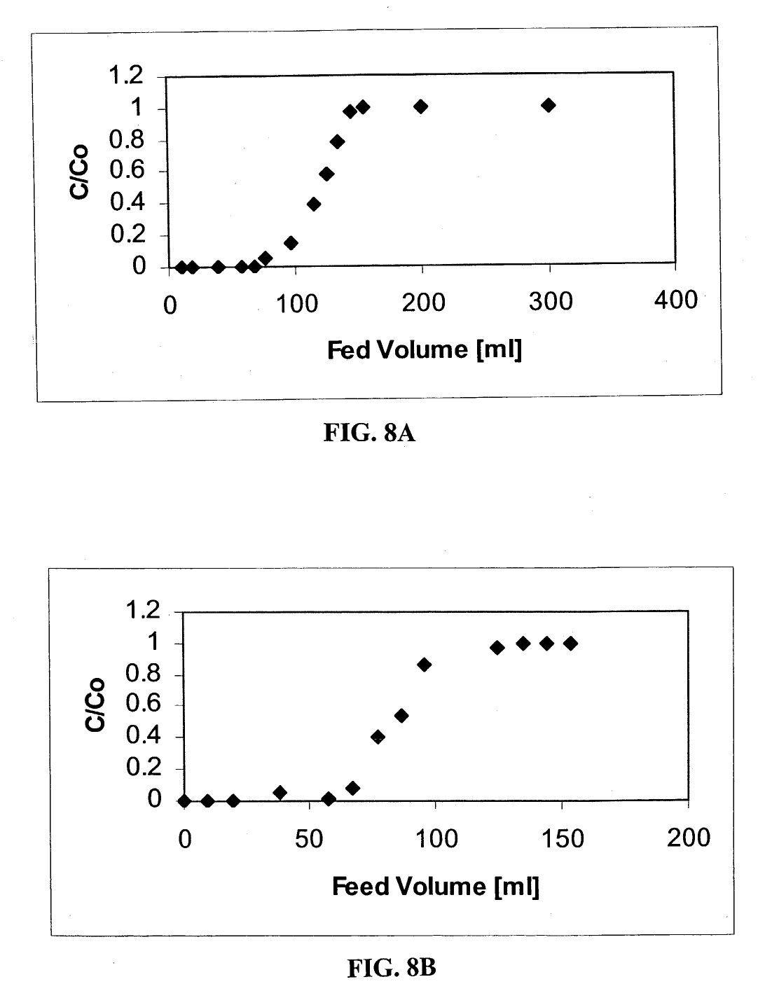

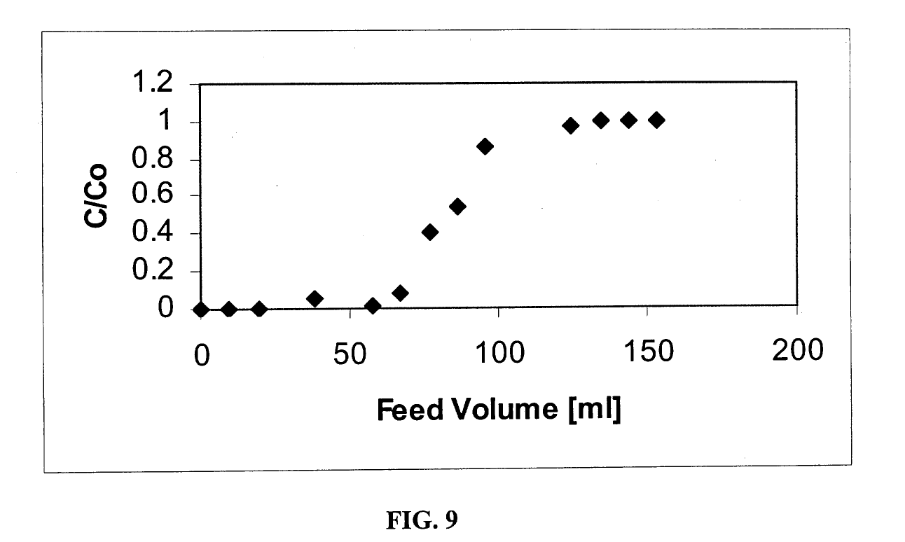

The breakthrough curves corresponding to the dynamic exchange of Pb²⁺, Ni²⁺, Cu²⁺ and Co²⁺ in the tested PFIEBR are shown in FIGS. 6A, 6B, 7A, 7B, 8A, 8B and 9. The bed volume is V_{B}≈0.8±0.1 cm³ for the column with a grain size (φ) of 0.6 mm to 0.8 mm; and the free bed volume is V_{B}≈1.0±0.1 cm³ for the column with a grain size (φ) 0.8 mm to 2.0 mm. The bed volumes are calculated using the Fed volume reported in the breakthrough curves, such as those shown in FIGS. 6A, 6B, 7A, 7B, 8A, 8B and 9. The results reported in Table 6 shows that Pb²⁺ is more selectively exchanged than Ni 2+, Co²⁺ and Cu²⁺, where the selectivity increases in the following order: Ni²⁺<Co²⁺<Cu²⁺<Pb²⁺.

### Example 4

### Parameters Which Describe the Operation of Real Plug Flow Ionic Exchange Bed Reactors

The operational parameters of the tested PFIEBR are shown in Table 6. Equation 5 is used to calculate τ. B_{C}, Dₒ and E are calculated based on the experimentally obtained breakthrough curves determined using Equations 6 to 9 and the established operational parameters F and φ.

TABLE 6
Operational parameters τ, B_{C}, Dₒ E, F and φ of the tested
Plug Flow Ionic Exchange Bed Reactor.

| | τ | B_{C} | Dₒ | E | F | φ |
|---|---|---|---|---|---|---|
| Cation | [sec] | [mequiv/g] | [cm] | [%] | [cm³/min] | [mm] |
| Pb²⁺ | 75 | 0.42 | 3.5 | 32 | 0.80 | 0.8-2 |
| Pb²⁺ | 60 | 1.25 | 1.0 | 75 | 0.80 | 0.6-0.8 |
| Ni²⁺ | <60 | 0.00 | >3.7 | 0 | 0.80 | 0.8-2 |
| Ni²⁺ | 148 | 0.30 | 3.3 | 40 | 0.32 | 0.6-0.8 |
| Ni²⁺ | 60 | 0.27 | 3.4 | 35 | 0.80 | 0.6-0.8 |
| Co²⁺ | 148 | 0.27 | 2.3 | 51 | 0.32 | 0.6-0.8 |
| Cu²⁺ | 148 | 0.57 | 2.1 | 52 | 0.32 | 0.6-0.8 |
| Cu²⁺ | 75 | 0.45 | 2.4 | 50 | 0.80 | 0.6-0.8 |

Note:
The errors in τ, B_{C}, Dₒ, E and F are: 10 sec; 0.05 mequiv/g; ± 0.3 cm; ± 5%; and 0.02 cm³/min, respectively.

The results included in Table 6 indicate that, in relation to the dynamic aspect of the ionic exchange in zeolite beds, a contact time (τ) of less than 60 seconds, is not a practical operational parameter for a PFIEBR with a natural zeolite column. Therefore, a contact time (τ)>60 seconds is necessary for an effective operation of a PFIEBR. Also, it is evident that a zeolite grain size (φ)>0.8 mm is not proper for the operation of the tested PFIEBR. Consequently, if the internal diameter of the ionic exchange column (d)=0.732 cm, then in a preferred embodiment of the present invention, the design of the PFIEBR includes the following relationship between the zeolite grain size and the internal diameter of the ionic exchange column: (φ)≦0.1 d.

It is possible to calculate the rate coefficient (k), using Equations 15 and 18 as well as the results for D₀ and F reported in Table 6. Table 7 reports the experimental values measured, in the reported examples, for the rate coefficient, k, in the dynamic cationic exchange of Pb²⁺, Ni²⁺, Co²⁺ and Cu²⁺ in a Na-Clinoptilolite column. The diffusion kinetics of the ionic exchange of Ni²⁺ in a natural Clinoptilolite has been shown to be R=0.013±0.002 sec⁻¹. See, Roque-Malherbe, 2001. The value obtained for the rate constant (R) calculated using Equation 3, agrees reasonably well with the data reported in Table 7 for k, in the case of Ni²⁺. This data supports the important determination made in the instant specification that diffusion in the zeolite secondary porosity is the rate determining process, which can be used as a valid approximation to describe the dynamic ionic exchange in a zeolite column.

TABLE 7
Operational parameter k and the previously reported
parameters F and φ of the tested
Plug Flow Ionic Exchange Bed Reactor.

| | k | F | φ |
|---|---|---|---|
| Cation | [sec⁻¹] | [cm³/min] | [mm] |
| Pb²⁺ | 0.04 | 0.80 | 0.8-2 |
| Pb²⁺ | 0.14 | 0.80 | 0.6-0.8 |
| Ni²⁺ | — | 0.80 | 0.8-2 |
| Ni²⁺ | 0.018 | 0.32 | 0.6-0.8 |
| Ni²⁺ | 0.040 | 0.80 | 0.6-0.8 |
| Co²⁺ | 0.025 | 0.32 | 0.6-0.8 |
| Cu²⁺ | 0.027 | 0.32 | 0.6-0.8 |
| Cu²⁺ | 0.058 | 0.8 | 0.6-0.8 |

Note:
The error in k is ±0.003 sec⁻¹

Table 7 shows that k¹=[0.018±0.003] sec⁻¹, which is the rate coefficient (k) measured for the dynamic ionic exchange of Ni^{2+.} Therefore, the longest length of the MTZ can be calculated by substituting in Equation 20 the numerical value of k¹, as follows:

Dₒ≈{W/k¹} ln {100}=CW

This relationship is used to calculate the following semi-empirical Equations 21 and 21a:

Dₒ≈CW [m] (Equation 21).

where: C=[260±100] [sec] (Equation 21a)

The method of the present invention for calculating the dimensions of the modular canister or set of modular canisters to be used, employs:

(a) Equation 21 to calculate the maximum length of the MTZ (Dₒ);

(b) the previously estimated operational parameters of the PFIEBR, that is: τ>60 seconds and φ≦0.1 d; and

(c) the total cation exchange capacity of the packed natural zeolite.

Since Ni²⁺ is one of the less selectively exchanged heavy metal cations in natural zeolites, because of thermodynamic reasons, the calculations and relationships determined for Ni²⁺ can be applied to heavy metal cations that are more selectively exchanged in natural zeolites. This method of the present invention for calculating the dimensions of the modular ionic exchange canister(s) or column(s), therefore, can be used with a relatively high degree of generality, to design the Modular Canister Ionic Exchange Bed Reactors packed with natural zeolites, such as, Clinoptilolite, Chabazite, Phillipsite, Modenite and Gismondine, each in sodium form. See, Roque-Malherbe, et al., 1987; Tsisihsvili et al., 1992; Colella, 1996.

Cations with low hydration heats are selectively exchanged by zeolites, because of the considerable contribution of the term DH to the differential heat of ion-exchange, Q_{d}. See Roque-Malherbe, et al., 1987; Tsisihsvili et al., 1992 and Colella, 1996. The ionic radius of Pb²⁺ is 1.19 Å. The ionic radius of Ni²⁺, Co²⁺ and Cu²⁺ are 0.70 Å, 0.70 Å and 0.73 Å respectively, as shown in Table 8. The general rule is that the cation with the higher cationic radius has the lowest enthalpy of hydration. It follows, therefore, that Pb²⁺ has a lower enthalpy of hydration than Ni²⁺, Co²⁺ and Cu²⁺, as shown in Table 8. Consequently, because Pb²⁺ has a lower enthalpy of hydration, it is evidently more selectively exchanged by a natural zeolite than Ni²⁺ Co²⁺ and Cu²⁺.

In the case of cations having a similar ionic radius, such as cooper, cobalt and nickel, a more detailed analysis must be made. Specifically, Cu²⁺ is more efficiently exchanged than Co²⁺ and Ni²⁺. Since, the difference in ionic radius, between these cations is almost non-existent, the difference in the hydration heats of Cu²⁺, Co²⁺ and Ni²⁺ is also insignificant, as shown in Table 8. Therefore, the above stated rule, that cation with the higher cationic radius has the lowest enthalpy of hydration, is not clearly applicable in this case. It is necessary, therefore, to explain these facts from the standpoint of the structure of the hydration complex formed in solution and in the zeolite by Cu²⁺, Co²⁺ and Ni²⁺. The existent experimental evidence show that the hydrated complex of Co²⁺ and Ni²⁺ are hexa-coordinated with an octahedral geometry i.e., Co (H₂O)₆²⁺ and Ni(H₂O)₆²⁺. In the case of Cu²⁺ the octahedral configuration is not stable, consequently a planar tetrahedral configuration Cu(H₂O)₄²⁺ is found in solution. The lower coordination of the Cu(H₂O)₄²⁺ complex implies less geometric constraint and a higher interaction with the zeolite framework in comparison to the Co (H₂O)₆²⁺ and Ni(H₂O)₆²⁺ hexa-coordinated complexes. These facts could explain why Cu²⁺ is more efficiently exchanged by Na-Clinoptilite than Co²⁺ and Ni²⁺. The differences between Co²⁺ and Ni²⁺ reported here are in the range of the experimental error, consequently there is no place for any analysis.

TABLE 8
Hydration Enthalpies (−Hₐ) versus cationic radius (R)

| | | Hydration |
|---|---|---|
| | Cationic | Enthalpies |
| Cation | Radius (Å) | [kJ/mol] |
| Be²⁺ | 0.45 | 2484 |
| Ni²⁺ | 0.70 | 2096 |
| Co²⁺ | 0.70 | 2010 |
| Cu²⁺ | 0.73 | 2099 |
| Cd²⁺ | 0.95 | 1809 |
| Ca²⁺ | 1.00 | 1579 |
| Sr²⁺ | 1.18 | 1446 |
| Pb²⁺ | 1.19 | 1485 |
| Ba²⁺ | 1.35 | 1309 |

C. D. Schoeffer, Jr, C. A. Strausser, N. W. Thomsen and C. H. Yoder, Data for General Inorganic, Organic and Physical Chemistry, INTERNET, htttp://wulfenite.fandm 2002.

Summary of Equations Presented in the Instant Specification

z_{B}A^{zA+}+BZ [symbol] AZ+z_{A}B^{zB+} 1

Q_{d}=ΔH−DH 2

r=−RC 3

U(t)={Q_{B}(0)−Q_{B}(t))/(Q_{B}(0)−Q_{B}(∞)}=Q_{A}(t)/Q_{A}(∞)=1−exp[−Rt]≅Rt 3a

U(t)≅[1−exp(−Bt)]^{1/2} 4

B=D^{I}π²/a² 4a

τ=V_{B}/F 5

Dₒ=2D{(V_{b}−Vₑ)/(V_{b}+Vₑ)} 6

B_{C}={[CₒVₑ]/M} 7

S_{C}={[CₒV_{b}]/M} 8

E=B_{C}/S_{C} 9

IN−OUT=ACCUMULATION 10

r_{A}=kC(x)ⁿ 11

F_{A}(x)=C(x)F 12

F_{A}(x)−{F_{A}(x)+dF_{A}(x)}=r_{A}dV=r_{A}Sdx 13

−FdC(x)=SkC(x)dx 14

−{dC(x)/C(x)}={kS/F}dx 14a

W={F/S} 15

−{dC(x)/C(x)}={k/W}dx 16

Cₑ Dₒ

∫−{dC(x)/C(x)}=∫dx

Cₒ 0 17

Dₒ={W/k} ln {Cₒ/Cₑ} 18

2D{(V_{b}−Vₑ)/(V_{b}+Vₑ)}={W/k} ln {Cₒ/Cₑ} 19

Dₒ≈{W/k¹} ln {100}=CW 20

Dₒ≈CW [m] 21

C=[260±100] [sec] 21a

Summary of the Abbreviations Used in the Instant Specification

α=fraction of free volume in the bed

φ=grain size

τ=minimum contact time

ρ=zeolite crystal density

ΔH=heat evolved in the zeolite={E_{B}−E_{A}(z_{B}/z_{A})}

ρV_{c}=mass of the unit cell

Å angstroms; used to measure cationic radius

a=effective radius of the zeolite crystals

AZ=cations of atom A in the zeolite

A^{zA+}=cations of atom A in solution

BZ=cations of atom B in the zeolite

B^{zB+}=cations of atom B in solution

C=range of values Cₘᵢₙ<C<Cₘₐₓ

C(x)=concentration profile

C=concentration of the cation of atom B in the interface zeolite grain-adhered liquid thin layer

Cₑ=breakthrough concentration

Cₒ=initial concentration (mass/volume)

CPS=counts per second

D=column length or distance

d=internal diameter of the ionic exchange column

DH=heat evolved in the solution during the cationic exchange process={E_{B}−E_{A}(z_{B}/z_{A})}≈{H_{B}−H_{A}(z_{B}/z_{A})}

D^{I}=interdiffusion coefficient

Dₒ=MTZ length

E_{A}=the partial molar internal energies of cation A^{zA+} in solution

E_{A}=the partial molar internal energies of cation A^{zA+} in the zeolite

E_{B}=the partial molar internal energies of cation B^{zB+} in solution

E_{B}=the partial molar internal energies of cation B^{zB+} in the zeolite

F=volumetric flow rate; Volume/time or (ΔV/Δt) usually in cm³/min

F(x)=the product of F and C(x)

GR=zeolite sample from Dzegvi, Ga.

H_{A}=hydration heat cation A involved in the cation exchange reaction (Equation 1)

H_{B}=hydration heat cation B involved in the cation exchange reaction (Equation 1)

HC=zeolite sample from Castillas, Province of Havana, Cuba

I=Equilibrium Zone—saturated portion of bed

II=Mass Transfer Zone (MTZ) with a length Dₒ

III=unused zone

k=rate coefficient k [sec⁻¹]

M=mass

MCIEBR=Modular Canister Ionic Exchange Bed Reactor

MTZ=mass transfer zone

NA^{Al}/N_{Av}=total number of equivalents of exchangeable cations per unit cell

N^{Al}=number of Al atoms per framework unit cell

N_{Av}=the Avogadro number

PFIEBR=Plug Flow Ionic Exchange Bed Reactor

Q_{A}(∞)=equilibrium magnitude

Q_{A}(t)=magnitude of the cation of atom A in the zeolite at time=t

Q_{B}(∞)=equilibrium magnitude

Q_{B}(0)=initial magnitude of cation of atom B in the zeolite

Q_{B}(t)=magnitude of the cation of atom B in the zeolite at time=t

Q_{d}=differential heat of ion-exchange

r=dC/dt

R=rate constant of the interdiffusion in the adhered liquid thin layer

R in Equation 3A=slope of the curve, U(t) versus time

r_{A} reaction rate producing accumulation of cations of atom A in the zeolite [mass/volume/time]

SW=zeolite sample from Sweetwater, Wyo., USA

TCEC=Total Cation Exchange Capacity (usually in mequiv/g)=[(N^{Al}/N_{Av})/(ρV_{c})]

V=volume of the empty bed

V_{b}=fed volume to saturation

V_{B}=bed volume

V_{c}=volume of the framework unit cell

Vₑ=fed volume of the aqueous solution of A{a_{A}+} to breakthrough

W=hydraulic load

x=distance traveled

XRD=X-ray diffraction

z_{A}+=charge of the cations of the atom A

z_{B}+=charge of the cations of the atom B

One embodiment of the present invention provides method that includes: receiving a wastewater containing a heavy metal cation into a natural zeolite column; and removing the heavy metal cation within a mass transfer zone of the natural zeolite column, wherein the mass transfer zone has a distance that is sized based on a hydraulic loading of the wastewater. In a preferred embodiment of the method of the present invention, the distance of the mass transfer zone is about 125 to about 130 the hydraulic loading. Preferably, the hydraulic loading is a ratio of a flow rate of the wastewater to a cross-section area of the-mass transfer zone.

In yet another embodiment of the method and system of the present invention include flowing the wastewater through an equilibrium zone of the natural zeolite column prior to receiving the wastewater into the mass transfer zone. Also, the method can include flowing the wastewater through an unused zone of the natural zeolite column after removing the heavy metal in the mass transfer zone.

In the embodiments of the present invention, the heavy metals can be any heavy metals; preferably they include at least one of lead, nickel, cobalt, and copper.

It is yet another embodiment of the present invention to provide a system for removing a heavy metal from a wastewater in which the system includes a mass transfer zone for removing the heavy metal from the wastewater, wherein the MTZ includes a distance that is sized based on a hydraulic loading of the wastewater. In a preferred embodiment of the system of the present invention, the distance of the MTZ is about 127.9 times the hydraulic loading. In a preferred embodiment of the system of the present invention, the hydraulic loading is a ratio of a flow rate of the wastewater to a cross-section area of the mass transfer zone. The system includes an equilibrium zone upstream of the mass transfer zone and an unused zone downstream of the mass transfer zone.

Yet another embodiment of the present invention provides a modular canister ionic exchange bed reactor comprising: an equilibrium zone for receiving a wastewater having a heavy metal; and a mass transfer zone downstream of the equilibrium zone, wherein the mass transfer zone has a distance equals to about 127.9W, wherein W is a hydraulic loading of the wastewater. In such an embodiment of the present invention, the mass transfer zone is housed within a canister of the modular canister ionic exchange bed reactor. In a most preferred embodiment of the system and MCIEBR, the canister is removable. Also, in a preferred embodiment of the present invention, the canister is recyclable. In a most preferred embodiment of the present invention's methods, systems and modular canister ionic exchange bed reactor, the mass transfer zone contains a natural zeolite. In a preferred embodiment, the natural zeolite is a Na-Clinoptilolite. Preferably, once that the natural zeolite is saturated with the heavy metal, the saturated natural zeolite is removed from the canister. A new canister containing natural zeolite can replace that which was removed, and/or the fresh natural zeolite can be place in the used canister for reuse of the canister.

Another embodiment of the present invention provides a method for the designing a system of Modular Canister Ionic Exchange Bed Reactors, which uses of the following semi-empirical equation: Dₒ≈CW [m]. In the method for designing a MCIEBR, preferably the concentration range of exchanged cation is from about 160 to about 360; also preferred is a minimum contact time that is greater than 60 seconds. It is also a preferred embodiment of the present invention to use a natural zeolite having a grain size that is less than or equal to about one tenth the internal diameter of the ionic exchange column, In a further embodiment of the present invention, the total cation exchange capacity (TCEC) of the packed natural zeolite is greater than about 1.0 mequiv/g and less than about 4.0 mequiv/g.

Yet another embodiment of the present invention provides a method for removing heavy metal cations from wastewater, said method comprising the following steps: (a) analyzing the wastewater to be treated to determine and quantify the contained heavy metals; (b) determining the wastewater flow rate; (c) selecting a natural zeolite selected from the group consisting of the sodium form of Clinoptilolite, Chabazite, Phillipsite, Modenite and Gismondine, said selecting based on cost, availability, and quality of said zeolite; (d) calculating the dimensions of the at least one modular canister to be used; and (e) estimating the time at which the system will be exhausted, said estimating comprising consideration of factors, said factors comprising: the zeolite TCEC, the concentration of the heavy metals contained in the wastewater; and the wastewater flow rate. In a preferred embodiment of the method of the present invention, the canister or canisters are manufactured for a specific application. In a preferred embodiment of the present invention, the dimensions of said canister provides a mass transfer zone from about 125 to about 130 the hydraulic loading, most preferably the dimensions of a canister provides a mass transfer zone from about 127 to about 128 the hydraulic loading. In a preferred embodiment of the method of the present invention, the dimensions of a canister is performed using the equation: 2D{(V_{b}−Vₑ)/(V_{b}+Vₑ)}={W/k} ln {Cₒ/Cₑ}. In yet another preferred embodiment of the method and system of the present invention, the concentration range of exchanged cation is from about 160 to about 360; also preferred is a minimum contact time that is greater than 60 seconds. It is also a preferred embodiment of the present invention to use a natural zeolite having a grain size that is less than or equal to about one tenth the internal diameter of the ionic exchange column, In a further embodiment of the present invention, the total cation exchange capacity (TCEC) of the packed natural zeolite is greater than about 1.0 mequiv/g and less than about 4.0 mequiv/g.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for removing heavy metal cations from wastewater comprising:
receiving a wastewater containing a heavy metal cation into a natural zeolite column; and
removing the heavy metal cation within a mass transfer zone of the natural zeolite column, wherein the mass transfer zone has a distance that is sized based on a hydraulic loading of the wastewater.

2. The method of claim 1, wherein the distance of the mass transfer zone is about 125 to about 130 times the hydraulic loading.

3. The method of claim 2, wherein the hydraulic loading is a ratio of the flow rate of the wastewater to a cross-section area of the mass transfer zone.

4. The method of claim 1, wherein said wastewater flows through an equilibrium zone of the natural zeolite column prior to receiving the wastewater into the mass transfer zone; and said wastewater flows through an unused zone of the natural zeolite column after removing the heavy metal in the mass transfer zone.

5. The method of claim 1, wherein the heavy metal cation is selected from the group consisting of lead, cobalt, copper, nickel and a combination thereof.

6. A system for removing a heavy metal from a wastewater comprising:
a natural zeolite ionic exchange bed having a mass transfer zone for removing the heavy metal from the wastewater, wherein the distance of said mass transfer zone is sized based on the hydraulic loading of the wastewater.

7. The system of claim 6, wherein said distance is about 125 to about 130 times the hydraulic loading.

8. The system of claim 6, wherein the hydraulic loading is a ratio of the flow rate of the wastewater to the cross-sectional area of the mass transfer zone.

9. The system of claim 6, further comprising an equilibrium zone upstream of the mass transfer zone and an unused zone downstream of the mass transfer zone.

10. The system of claim 6, wherein the heavy metal is selected from the group consisting of lead, cobalt, copper, nickel and a combination thereof.

11. A modular canister ionic exchange bed reactor system comprising at least one modular canister ionic exchange bed reactor, wherein said reactor comprises:
at least one natural zeolite ionic exchange bed having a an equilibrium zone for receiving wastewater containing a heavy metal; and
a mass transfer zone downstream of said equilibrium zone, wherein the mass transfer zone has a distance from about 125 to about 130 times the hydraulic loading of the wastewater.

12. The modular canister ionic exchange bed reactor of claim 11, wherein the mass transfer zone is housed within a canister.

13. The modular canister ionic exchange bed reactor of claim 11, wherein said at least one canister is removable.

14. The modular canister ionic exchange bed reactor of claim 11, wherein said at least one canister is recyclable.

15. The modular canister ionic exchange bed reactor of claim 11, wherein the natural zeolite in said natural zeolite ionic exchange bed is selected from the group consisting of the sodium form of Clinoptilolite, Chabazite, Phillipsite, Modenite and Gismondine.

16. The modular canister ionic exchange bed reactor of claim 15, wherein said natural zeolite is Na-Clinoptilolite.

17. The modular canister ionic exchange bed reactor of claim 11, wherein when said natural zeolite ionic exchange bed is saturated with a heavy metal, the canister containing said saturated bed is removed from the reactor and a natural zeolite ionic exchange bed containing canister replaces said removed canister.

18. A method for designing a system of Modular Canister Ionic Exchange Bed Reactors, wherein said method is characterized by determining the length of the mas transfer zone in said reactors based on the following relationships, which are captured in the equation: Dₒ≈CW [m].

19. The method of claim 18, wherein said concentration range (C) of exchanged cation is from about 160 to about 360 grams/Liter; wherein the minimum contact time is greater than 60 seconds; wherein the zeolite grain size is less than or equal to about one tenth the internal diameter of the ionic exchange column; and wherein the total cation exchange capacity (TCEC) of the packed natural zeolite is greater than about 1.0 mequiv/g and less than about 4.0 mequiv/g.

20. A method for removing heavy metal cations from wastewater, said method comprising the following steps:
(a) analyzing the wastewater to be treated to determine and quantify the contained heavy metal cations;
(b) determining the wastewater flow rate;
(c) selecting a natural zeolite for use in at least one ion echange column or canister, wherein said zeolite is selected from the group consisting of the sodium form of Clinoptilolite, Chabazite, Phillipsite, Modenite and Gismondine;
(d) calculating the dimensions of the column(s) or canister(s); and
(e) estimating the time at which the column(s) or canister(s) will be exhausted.

21. The method of claim 20, wherein said selecting of said natural zeolite is based on zeolite cost, zeolite availability, and zeolite quality.

22. The method of claim 20, wherein said estimating of the time comprises considering the total cation exchange capacity of the zeolite; the concentration of the least selectively exchanged heavy metal cation contained in the wastewater; and the wastewater flow rate.

23. The method of claim 20, wherein said column(s) or canister(s) are manufactured for a specific application.

24. The method of claim 20, wherein the dimensions of said column or canister provides a mass transfer zone having a length that is from about 125 to about 130 times the hydraulic loading.

25. The method of claim 24, wherein the dimensions of said column or canister provide a mass transfer zone having a length that is from about 127 to about 128 times the hydraulic loading.

26. The method of claim 20, wherein said calculating is performed using the equation: 2D{(V_{b}−V_{c})/(V_{b}+Vₑ)}l={W/k} ln {Cₒ/Cₑ}.

27. The method of claim 20, wherein the concentration range of the exchanged cation is from about 160 to about 360 grams/liter; wherein the minimum contact time is greater than 60 seconds; wherein said natural zeolite has a grain size that is less than or equal to about one tenth the internal diameter of the ionic exchange column; and wherein the total cation exchange capacity of the packed natural zeolite is greater than about 1.0 mequiv/g and less than about 4.0 mequiv/g.
